(19) United States
(12) Patent Application Publication
(10) Pub. No.: US 2023/0268652 A1
(43) Pub. Date: Aug. 24, 2023

(54) BROAD BAND DIRECTIONAL ANTENNA

(71) Applicant: POYNTING ANTENNAS (PTY) LIMITED, Centurion (ZA)

(72) Inventors: Derek Colin NITCH, Witkoppen ext .6 (ZA); Shane Alexander MOYCE, Gauteng (ZA)

(21) Appl. No.: 18/170,519

(22) Filed: Feb. 16, 2023

(30) Foreign Application Priority Data
Feb. 18, 2022 (ZA) 2022/02053

(51) Int. Cl. H01Q 5/307; H01Q 1/48; H01Q 21/26; H01Q 9/04

(52) U.S. Cl. CPC H01Q 5/307; H01Q 1/48; H01Q 21/26; H01Q 9/0407

(57) ABSTRACT

A broad band directional antenna 10 comprises a patch antenna 12 comprising a conductive and non-circular patch 14 and having a main axis 16 extending perpendicularly to the patch. The antenna further comprises at least one active radiator 18.1, 18.2 which is axially spaced from the patch 14 in a first direction A. A metamaterial ground plane assembly 20 is located between the patch antenna 12 and the at least one active radiator 18.1, 8.2. The patch antenna 12 comprises a conductive ground plane 22 which is axially spaced from the patch 14 in a second and opposite direction B.

This application claims priority to Application No 2022/02053, filed Feb. 18, 2022 in South Africa, which application is incorporated by reference. To the extent appropriate, a claim of priority is made to each of the above disclosed applications

### INTRODUCTION AND BACKGROUND

This invention relates to a broad band directional antenna and more particularly to a broad band cross polarised directional antenna.

Broad band cross polarised antennas are of considerable interest due to the large variety of frequencies used in 4G/5G and other communications systems. Broadband type dipole radiators are often arranged above a ground plane reflector surface to achieve a main beam perpendicular to the ground plane surface. This arrangement suffers from frequency limitations, since the ideal spacing for such a radiator is around a quarter wavelength above the reflector surface and which hence causes it to be half a wavelength above the reflector surface for signals having twice such frequency, resulting in destructive interference towards the main beam direction and other pattern irregularities. Metamaterials may be used artificially to delay waves at some frequencies. Hence, positioning a metamaterial ground plane between a radiator and a conductive ground plane may assist in achieving a broader bandwidth. Such assemblies are known, but radiation pattern control (i.e. maintaining the same shape at all frequencies, in other words, maintaining pattern stability) is still problematic over a wide bandwidth. This is due to pseudo surface waves which can exist between the metamaterial ground plane and conductive ground plane and many other undesirable EM interactions, amongst other reasons.

An example of a broad band directional antenna comprising a metamaterial layer is disclosed in the applicant's international application which was published under number WO/2021/038381. The gain performance of this antenna at lower frequencies may not be suitable for some applications and the antenna may be considered cumbersome and therefore unnecessarily costly to manufacture and assemble.

### OBJECT OF THE INVENTION

Accordingly, it is an object of the present invention to provide a broad band directional antenna with which the applicant believes the aforementioned disadvantages may at least be alleviated and/or which may provide a useful alternative for the known antennas.

### SUMMARY OF THE INVENTION

According to the invention there is provided a broad band directional antenna comprising.
a patch antenna comprising a conductive and non-circular patch and having a main axis extending perpendicularly to the patch;
at least one active radiator which is axially spaced from the patch in a first direction; and
a metamaterial ground plane assembly located between the patch antenna and the at least one active radiator.

The patch antenna may comprise a conductive ground plane which is axially spaced from the patch in a second and opposite direction.

Shape, dimension and relative spacing of the conductive ground plane, the patch, the at least one active radiator and the metamaterial ground plane assembly are selected to improve antenna bandwidth, pattern consistency or stability and gain.

The non-circular patch may comprise at least five sides.

Preferably, the non-circular patch is octagonal in configuration.

The conductive ground plane and the metamaterial ground plane assembly may have any suitable shape, including a rectangular shape, but preferable a square shape, having four sides.

The metamaterial ground plane assembly may comprise a dielectric substrate with spaced conductive elements formed thereon. The elements may be arranged in repeated patterns.

In a preferred embodiment the elements may be arranged on a plurality of circles. Four elements may be arranged in equi-spaced relation on each circle and each element may be in the shape of a quadrant or circle sector having a central angle of 90°.

The at least one active radiator may comprise at least one dipole radiator.

In a preferred embodiment, the at least one active radiator comprises first and second cross polarized dipole radiators, which are driven at respective centre points.

The antenna may also comprise at least one passive radiator which is axially spaced from the at least one active radiator in the one direction.

In the preferred embodiment, the at least one passive radiator is of the same shape and configuration as the at least one active radiator, but smaller in size.

A surface area of the patch is preferably larger than a surface area of the metamaterial ground plane assembly.

According to another aspect of the invention there is provided a broad band directional antenna comprising:
a patch antenna comprising a conductive patch and having a main axis extending perpendicularly to the patch;
at least one active radiator which is axially spaced from the patch in a first direction; and
a metamaterial ground plane assembly located between the patch antenna and the at least one active radiator, wherein the metamaterial ground plane assembly comprises a substrate with spaced conductive elements formed thereon, wherein the elements are arranged in repeated patterns, wherein the patterns are circles, wherein four elements are arranged in equi-spaced relation on each circle and wherein each element is in the shape of a quadrant or circle sector having a central angle of 90°.

### BRIEF DESCRIPTION OF THE ACCOMPANYING DIAGRAMS

The invention will now further be described, by way of example only, with reference to the accompanying diagrams wherein:

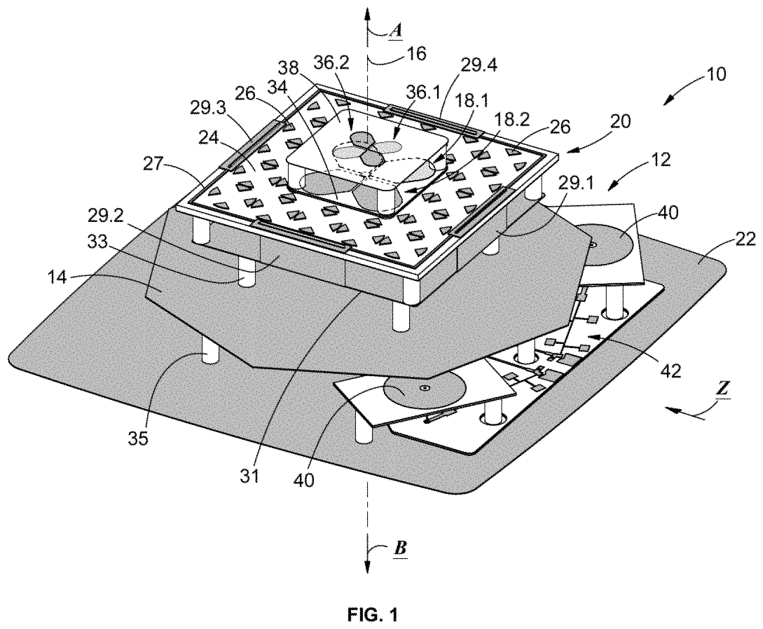

FIG. 1 is a diagrammatic perspective view of an example embodiment of a broad band directional antenna;

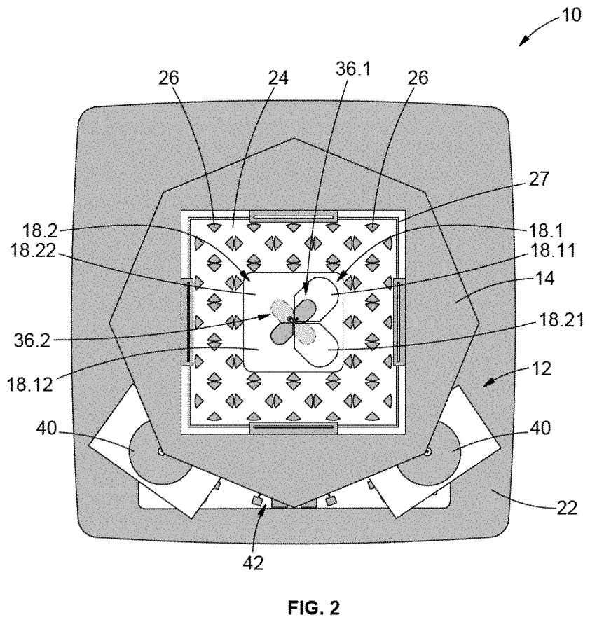

FIG. 2 is a plan view of the antenna in FIG. 1;

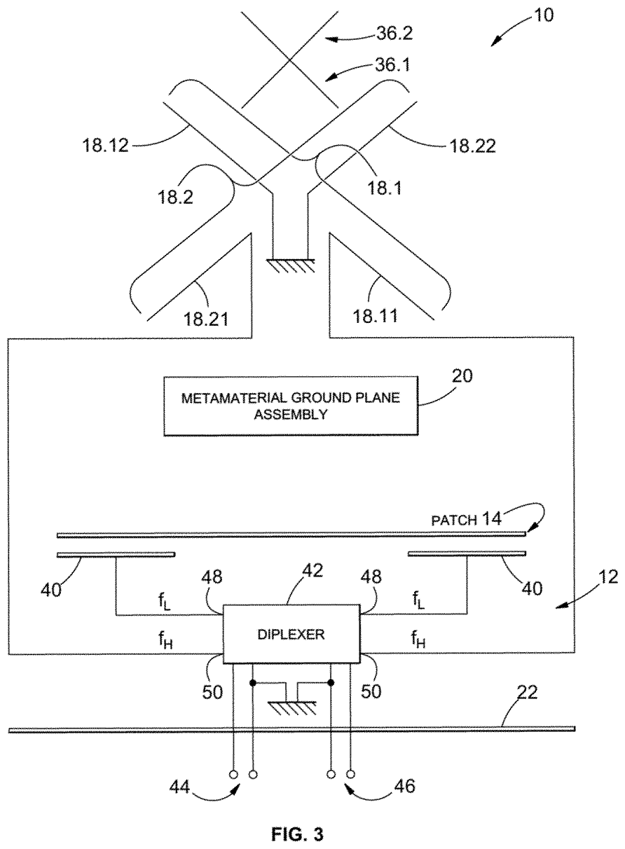

FIG. 3 is an electrical diagram of some elements of the antenna in FIG. 1;

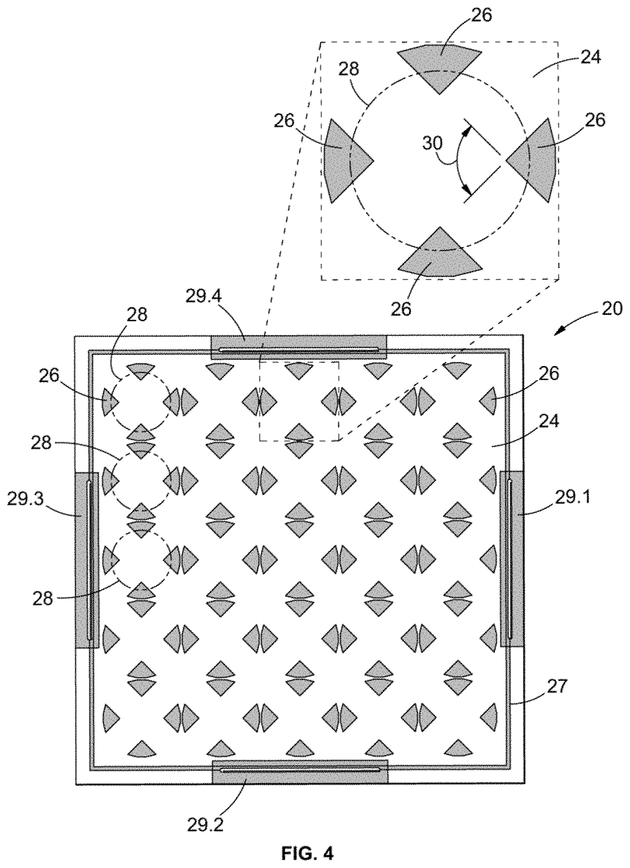

FIG. 4 is a plan view of a metamaterial ground plane assembly forming part of the antenna in FIG. 1;

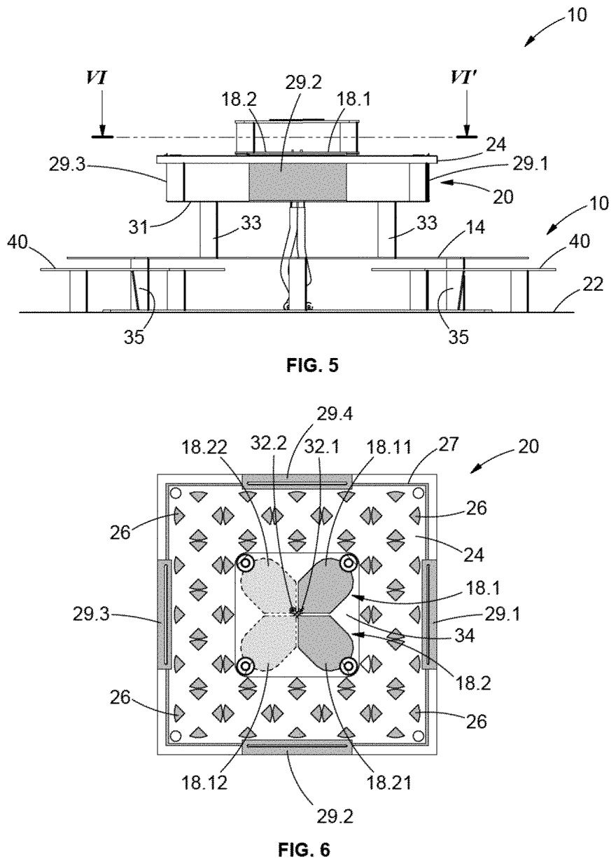

FIG. 5 is a side view in direction Z of the antenna in FIG. 1;

FIG. 6 is a section on line VI in FIG. 5;

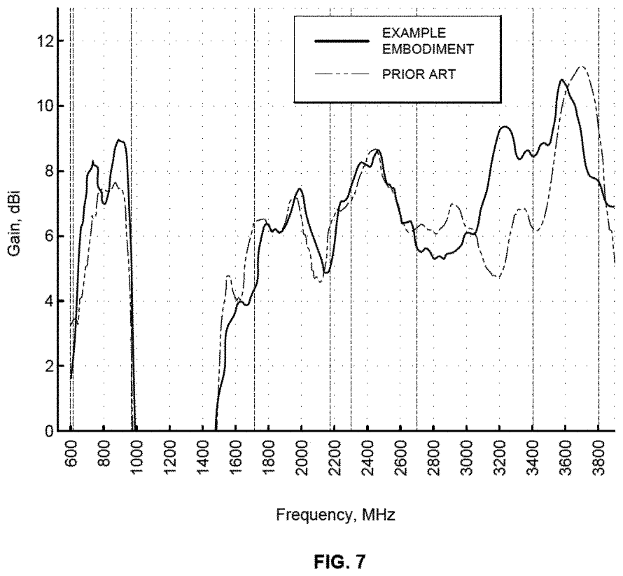

FIG. 7 is a plot of antenna gain against frequency over a full frequency band of the antenna in FIG. 1 compared to that of a prior art antenna;

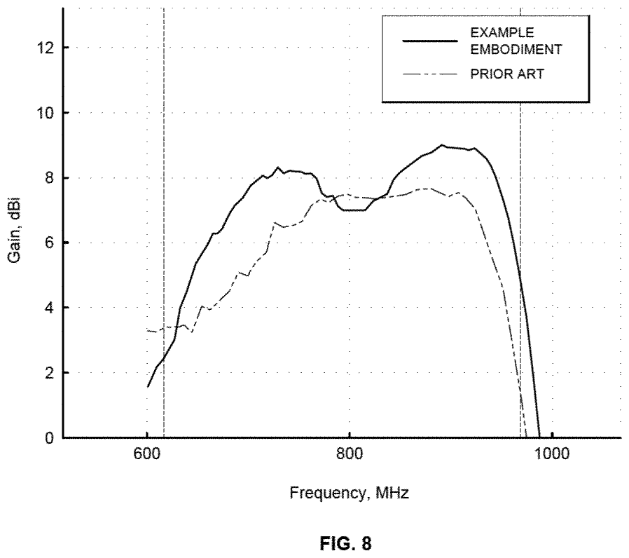

FIG. 8 is a similar plot for a lower part only of the frequency band;

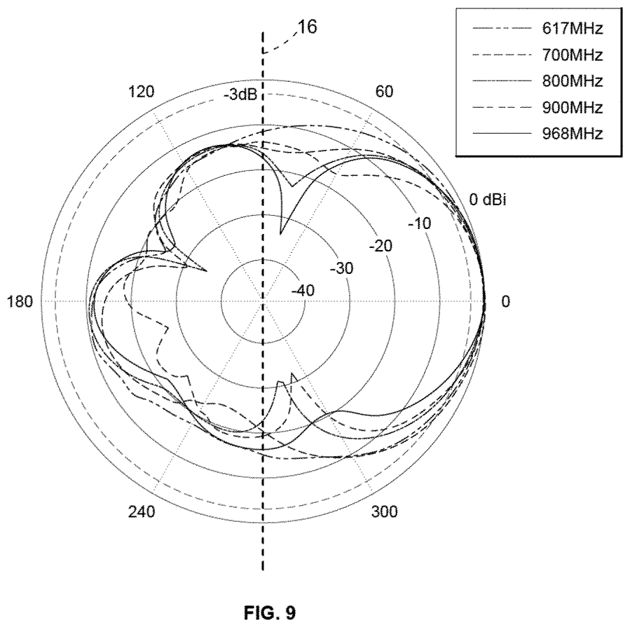

FIG. 9 is an elevational view of a radiation pattern of the antenna in FIG. 1 for five frequencies in the lower part of the frequency band;

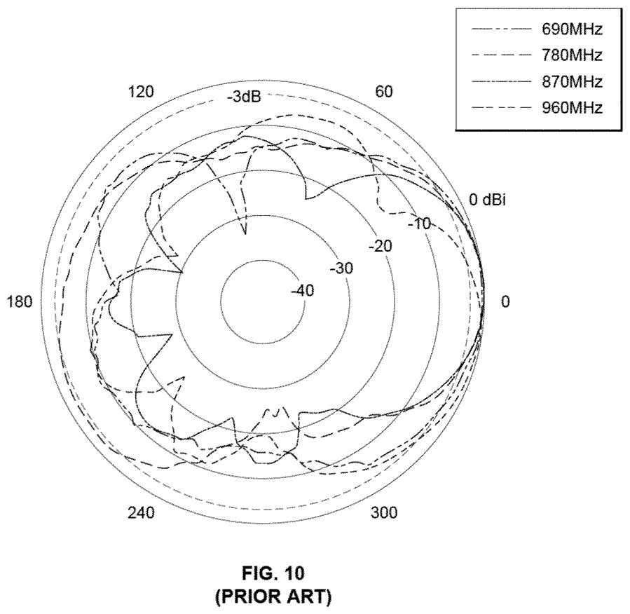

FIG. 10 is a similar view for the prior art antenna;

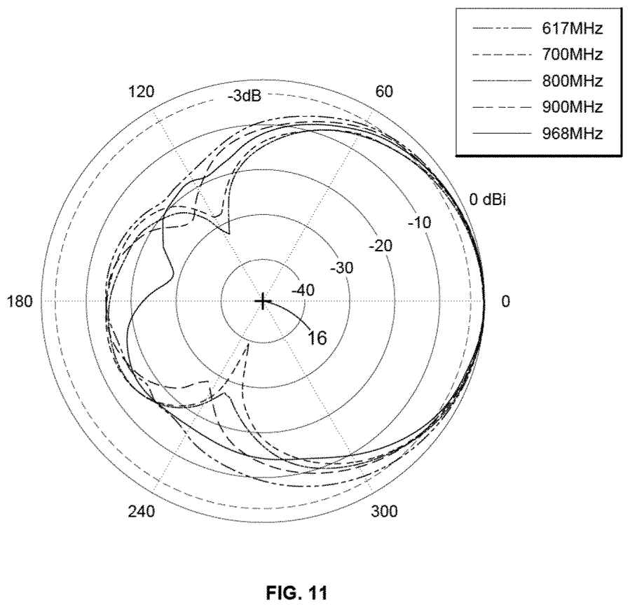

FIG. 11 is a plan view or the radiation pattern of the antenna in FIG. 1 for the five frequencies; and

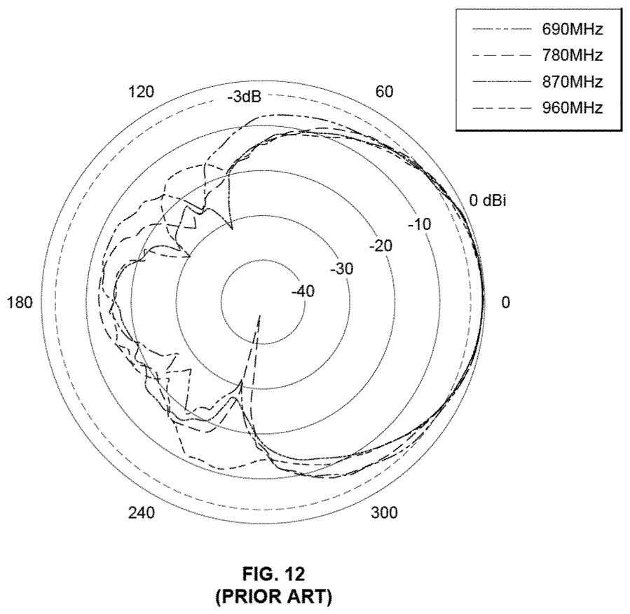

FIG. 12 is a similar view for the prior art antenna.

### DESCRIPTION OF A PREFERRED EMBODIMENT OF THE INVENTION

An example embodiment of a broad band directional antenna is generally designated by the reference numeral 10 in FIGS. 1, 2, 3 and 5.

Referring to FIG. 1, the broad band directional antenna comprises a patch antenna 12 comprising a conductive and non-circular patch 14 and having a main axis 16 extending perpendicularly to the patch. The antenna further comprises at least one active radiator 18.1, 18.2 which is axially spaced from the patch 14 in a first direction A. A metamaterial ground plane assembly 20 is located between the patch antenna 12 and the at least one active radiator 18.1, 8.2.

The patch antenna 12 comprises a conductive ground plane 22 which is axially spaced from the patch 14 in a second and opposite direction B.

As will become clearer below, the conductive ground plane 22, the patch 14 and the metamaterial ground plane assembly 20 may have any suitable shape and/or dimensions. However, shape, dimensions and relative spacing of the conductive ground plane 22, the at least one active radiator 18.1, 18.2 and the metamaterial ground plane assembly 20 and its constituent parts are selected to improve antenna bandwidth, pattern consistency or stability and gain.

In the example embodiment shown, the conductive non-circular patch 14 has at least five sides and preferably is octagonal in configuration.

Referring to FIGS. 1, 2 and 6, the metamaterial ground plane assembly 20 comprises a square dielectric substrate 24 on which there is provided a plurality of conductive elements 26 within a conductive frame 27. Referring to FIG. 4 in particular, the elements 26 are arranged in repeating patterns, more particularly on circles 28. There are four equi-spaced elements on each circle and each element is in the shape of a quadrant or circle sector having a central angle 30 of 90°. The conductive elements 26 may be formed on the dielectric substrate 24 according to known printed circuit board techniques.

The frame 27 is connected by depending conductive sidewall parts 29.1 to 29.4 to a conductive ground plane 31 of the assembly 20.

As best shown in FIG. 1, pillars 33 space the patch 14 from the conductive ground plane 31 of the assembly 20 and pillars 35 space the patch from conductive ground plane 22 of the patch antenna 12.

As best shown in FIG. 6 the at least one active radiator comprises first and second cross polarized dipole radiators 18.1 and 18.2 which are driven at respective centre points 32.1 and 32.2. One conductive element (18.11, 18.21) of each of the dipoles is provided on a top surface of a substrate 34, whereas the other element (18.12, 18.22) is provided on a bottom surface of the substrate 34.

Referring to FIGS. 1 to 3, the example embodiment of the antenna 10 comprises at least one passive radiator 36.1, 36.2 which is spaced from the at least one active radiator 18.1, 18.2 in the one direction A. In a preferred embodiment, the at least one passive radiator is of the same shape and configuration as the at least one active radiator, but smaller in size. The passive radiators 36.1, 36.2 are provided on a dielectric substrate 38.

The surface area of the patch 14 is preferably larger than the surface area of the metamaterial ground plane assembly 20. Known feeds for the patch 14 are shown at 40.

The example embodiment of the antenna 10 operates in the frequency band of about 600 MHz to 3.8 GHz.

Referring to FIG. 3, the example embodiment of the antenna 10 further comprises a diplexer 42. Considering the antenna 10 in a transmitting mode, the diplexer 42 serves to divide signals at the input ports 44 and 46 into signals in a lower part of the band f_{L} at output ports 48 and signals in a higher part f_{H} of the band at output ports 50. It is well known that antennas are reciprocal devices that work in both transmitting and receiving modes. The ports 48 are connected to the drivers 40 for the patch antenna 12 and ports 50 are connected to the active radiators 18.1 and 18.2.

In FIG. 7, there is shown plots of antenna gain against frequency for the example embodiment of the antenna 10 (shown by the bold line) and a prior art antenna (shown by the fainter line). The plots clearly indicate an unexpected increase in gain of about 1 dB to 2 dB for frequencies below 1 GHz for the example embodiment of the antenna. This is better illustrated in FIG. 8 and may be attributed to the configuration of the patch 14. The plots in FIG. 7 also indicate an unexpected and significant improvement in gain in the band 3 GHz to 3.6 GHz. This may be attributed to the configuration of the metamaterial ground plane assembly 20.

The plots in FIGS. 9 and 11 for the example embodiment of the antenna 10 also clearly illustrate far more stable radiation patterns for the example embodiment of the antenna 10 compared to that of the prior art antenna which are shown in FIGS. 10 and 12.

1. A broad band directional antenna comprising:
a patch antenna comprising a conductive and non-circular patch and having a main axis extending perpendicularly to the patch;
at least one active radiator which is axially spaced from the patch in a first direction; and
a metamaterial ground plane assembly located between the patch antenna and the at least one active radiator.

2. The broad band directional antenna as claimed in claim 1 wherein the patch antenna comprises a conductive ground plane which is axially spaced from the patch in a second and opposite direction.

3. The broad band directional antenna as claimed in claim 1 wherein the non-circular patch comprises at least five sides.

4. The broad band directional antenna as claimed in claim 3 wherein the non-circular patch is octagonal in configuration.

5. The broad band directional antenna as claimed in claim 1 wherein the metamaterial ground plane assembly has a shape selectable from a rectangular shape and a square shape.

6. The broad band directional antenna as claimed in claim 2 wherein the conductive ground plane has a shape selectable from a rectangular shape and a square shape.

7. The broad band directional antenna as claimed in claim 1 wherein the metamaterial ground plane assembly comprises a dielectric substrate with spaced conductive elements formed thereon.

8. The broad band directional antenna as claimed in claim 7 wherein the elements are arranged in repeated patterns.

9. The broad band directional antenna as claimed in claim 8 wherein the elements are arranged on a plurality of circles.

10. The broad band directional antenna as claimed in claim 9 wherein four elements are arranged in equi-spaced relation on each circle and wherein each element is in the shape of a quadrant or circle sector having a central angle of 90°.

11. The broad band directional antenna as claimed in claim 1 wherein the at least one active radiator comprises at least one dipole radiator.

12. The broad band directional antenna as claimed in claim 11 wherein the at least one active radiator comprises first and second cross polarized dipole radiators, which are driven at respective centre points.

13. The broad band directional antenna as claimed in claim 1 comprising at least one passive radiator which is axially spaced from the at least one active radiator in the first direction.

14. The broad band directional antenna as claimed in claim 13 wherein the at least one passive radiator is of the same shape and configuration as the at least one active radiator, but smaller in size.

15. The broad band directional antenna as claimed in claim 1 wherein a surface area of the patch is larger than a surface area of the metamaterial ground plane assembly.

16. A broad band directional antenna comprising:
a patch antenna comprising a conductive patch and having a main axis extending perpendicularly to the patch;
at least one active radiator which is axially spaced from the patch in a first direction; and
a metamaterial ground plane assembly located between the patch antenna and the at least one active radiator, wherein the metamaterial ground plane assembly comprises a substrate with spaced conductive elements formed thereon, wherein the elements are arranged in repeated patterns, wherein the patterns are circles, wherein four elements are arranged in equi-spaced relation on each circle and wherein each element is in the shape of a quadrant or circle sector having a central angle of 90°.
